(19) United States
(12) Patent Application Publication
(10) Pub. No.: US 2024/0057646 A1
(43) Pub. Date: Feb. 22, 2024

(54) METHOD OF MANUFACTURING RADISH-WRAPPED FOR SUSHI AND RADISH-WRAPPED FOR SUSHI USING THE SAME

(71) Applicant: Sung Yong SONG, Englewood, NJ (US)

(72) Inventor: Sung Yong SONG, Englewood, NJ (US)

(21) Appl. No.: 17/889,826

(22) Filed: Aug. 17, 2022

(51) Int. Cl. A23L 19/10; A23L 19/20; A23L 5/43

(52) U.S. Cl. CPC A23L 19/10; A23L 19/20; A23L 5/43

(57) ABSTRACT

The present invention relates to a method of manufacturing radish-wrapped and radish-wrapped for sushi manufactured thereby.

The method of manufacturing radish-wrapped for sushi according to the present invention makes it possible to manufacture radish-wrapped with a thin thickness which can easily wrap sushi. In addition, the radish-wrapped manufactured by the present invention can provide a crunchy texture and add umami to sushi. Furthermore, the radish-wrapped manufactured by the present invention is pickled, so it is easy to store for a long period of time, and perforations are drilled so that the peculiar smell of radish can be removed and formation of air bubbles in ingredients in sushi can be blocked, and as a result, it has an excellent effect of maintaining the taste of sushi even after a certain period of time.

### TECHNICAL FIELD

The present invention relates to a method of manufacturing radish-wrapped and radish-wrapped for sushi manufactured thereby.

### BACKGROUND ART

Sushi is a Japanese food with a history and tradition of over a thousand years, and is one of the traditional Japanese foods widely known not only in Korea but also around the world. The history of sushi is long, but the history of sushi in its present form is not very long. Before the 16th century, sushi was made through a fermentation process, but with the development of brewing vinegar after the 16th century, in the 17th century, vinegar was used instead of fermented fish to make sushi without an aging process, and around 1820, modern sushi combining fish and sushi emerged.

Among it, maki sushi is one of the most familiar types of sushi, and maki is a word from maku, which means “roll” in Japanese, and refers to sushi made by adding rice and various ingredients (fish meat, seafood, meat, chicken, vegetables or pickles, etc.) and rolling it with laver or seaweed. Maki sushi is presently very popular not only in Asia but also in America and Europe, as various ingredients can be put according to taste.

It is general to make maki sushi by rolling ingredients mainly using laver or seaweed, and Korean Patent No. 10-1598072 describes ‘method for preparation of dried laver for sushi and dried laver for sushi prepared thereby’, and Korean Patent Publication No. 10-2010-0091299 describes ‘method of manufacturing of salted kimchi radish and food comprising the same’, but they do not disclose at all about radish-wrapped for sushi provided so as to make maki sushi using radish or a method for manufacturing thereof.

### PRIOR ART

### Patent Document

(Patent document 0001) Korean Registered Patent No. 10-1598072

(Patent document 0002) Korean Patent Publication No. 10-2010-0091299

### DISCLOSURE

### Technical Problem

Accordingly, the present inventors have developed a method of manufacturing radish-wrapped for sushi that can add crunchy texture and umami to sushi without reducing the inherent taste of sushi ingredients.

An object of the present invention is to provide a method of manufacturing radish-wrapped for sushi comprising: (a) slicing washed radish into a thin and long strip shape; (b) placing the sliced radish in a container; (c) adding an ionized alkaline aqueous solution until the radish in the container is completely immersed in it and maintaining it for 18 hours to 30 hours; (d) adding a coloring agent or natural coloring agent to the ionized alkaline aqueous solution to color the radish; and (e) taking out the radish from the container and discharging excess fluid.

Another object of the present invention is to provide radish-wrapped for sushi manufactured according to the method of manufacturing.

### Technical Solution

In order to solve the problem, the present invention provides a method of manufacturing radish-wrapped for sushi comprising: (a) slicing washed radish into a thin and long strip shape; (b) placing the sliced radish in a container; (c) adding an ionized alkaline aqueous solution until the radish in the container is completely immersed in it and maintaining it for 18 hours to 30 hours; (d) adding a coloring agent or natural coloring agent to the ionized alkaline aqueous solution to color the radish; and (e) taking out the radish from the container and discharging excess fluid.

In addition, the present invention provides radish-wrapped for sushi manufactured according to the method of manufacturing.

### Advantageous Effect

The method of manufacturing radish-wrapped for sushi according to the present invention makes it possible to manufacture radish-wrapped with a thin thickness which can easily wrap sushi.

In addition, the radish-wrapped manufactured by the present invention can provide a crunchy texture and add umami to sushi.

Furthermore, the radish-wrapped manufactured by the present invention is pickled, so it is easy to store for a long period of time, and perforations are drilled so that the peculiar smell of radish can be removed and formation of air bubbles in ingredients in sushi can be blocked, and as a result, it has an excellent effect of maintaining the taste of sushi even after a certain period of time.

### BRIEF DESCRIPTION OF THE DRAWINGS

FIG. 1 shows a block diagram illustrating the steps of manufacturing radish-wrapped for sushi according to the present invention.

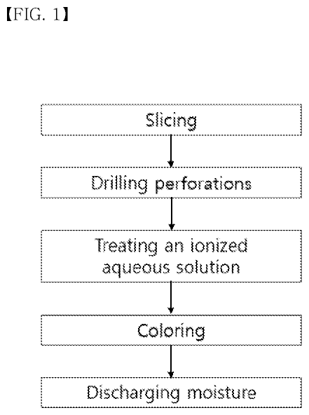

FIG. 2 is a drawing which shows a peeling device for peeling radish to make a thin and long shape of a strap.

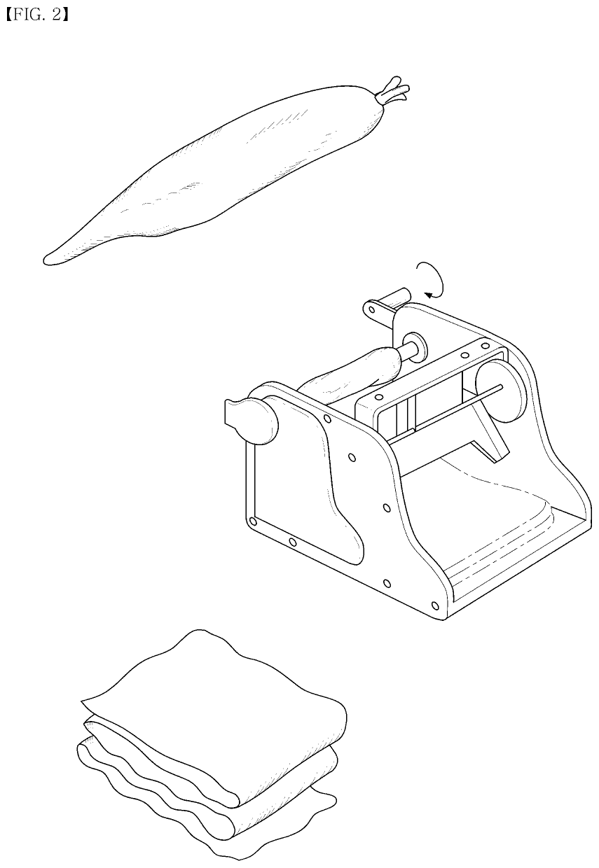

FIG. 3 is a drawing which shows a form of putting sliced radish in a container and supplying an ionized alkaline aqueous solution by an ionizer.

FIG. 4 is a drawing which shows a form of sushi completed by wrapping sushi ingredients using radish-wrapped for sushi.

### MODE FOR INVENTION

Hereinafter, the present invention will be described in more detail by examples.

The present invention provides a method of manufacturing radish-wrapped for sushi comprising: (a) slicing washed radish into a thin and long strip shape; (b) placing the sliced radish in a container; (c) adding an ionized alkaline aqueous solution until the radish in the container is completely immersed in it and maintaining it for 18 hours to 30 hours; (d) adding a coloring agent or natural coloring agent to the ionized alkaline aqueous solution to color the radish; and (e) taking out the radish from the container and discharging excess fluid.

In the step (a), slice means that radish is cut while peeling in a thin and long strip form. This process is called slicing, and the slicing process may be performed using a peeling device, but includes slicing using a knife or another peeling tool. In one example of the present invention, Vegg-Q peeler device (manufactured by UNI-TEC, Inc.), but not limited thereto.

In the step (a), the thickness of the sliced radish may be 0.05 mm to 3.00 mm, and may be preferably 0.25 mm to 1.50 mm, but not limited thereto.

In addition, the length of the sliced radish may be 5 cm to 30 cm, and the width may be 3 cm to 30 cm, but not limited thereto, and it may be made in a size suitable for wrapping sushi.

In the step (a), before the step (b), the sliced radish stacked by one sheet or several sheets and perforations at regular intervals are drilled. The perforation means a small hole in a circle form. Then, operation of drilling perforations may be conducted using an instrument, but not limited thereto.

By drilling the perforations, there is an effect of removing a unique odor of radish depending on the radish cultivation area, and there is an effect of blocking air bubbles that may occur when sushi ingredients are wrapped. However, depending on the condition of radish, when the smell of radish is mild or it has a sweat taste, the step of drilling perforations may be omitted.

The size of the diameter of the perforation is preferably 0.01 mm to 0.2 mm, and the interval between perforations is preferably 0.5 cm to 3 cm, but not limited thereto.

In the step (c), an ionized alkaline aqueous solution is added so that the radish placed in the container is sufficiently immersed and it is maintained for 18 hours to 30 hours.

The alkaline aqueous solution may be provided using a water ionizer. In one example of the present description, BHL-3100 water ionizer (available from Alkazone, 200 South Newman Street, Hackensack, N.J. 07601) was used, but not limited thereto.

The alkaline aqueous solution preferably has pH 7.0 to 10.0.

In the step (c), a process of pickling to add umami of radish may be included, and for this, vinegar and salt may be added. It is preferable to add the vinegar of 100 ml to 200 ml, and the salt of 2 to 4 table spoons, per 200 g of radish.

In the step (d), a coloring step is gone through in order to increase palatability of sushi. The coloring agent refers to one of solution, powder and a substance added to food or beverage on purpose of changing the color. The coloring agent includes a synthetic coloring agent and a natural coloring agent, and in one example of the present invention, a natural coloring agent was used. The natural coloring agent may be one or more kinds selected from the group consisting of green tea, gardenia fruit, carrot, pumpkin, blueberry, red cabbage, purple sweet potato, paprika, omija, gromwell root, safflower, indigo plant, cactus fruit, and red beet, but not limited thereto.

In the step (d), for coloring, a natural coloring agent is supplied by slicing in a container and then it is maintained for 6 hours to 18 hours to be colored.

In the step (e), it is a step of picking up the colored radish-wrapped to appropriately remove moisture.

In addition to the above steps, the radish-wrapped may be cut into a length of a size suitable for wrapping.

### Example 1. Manufacturing of Radish-Wrapped for Sushi

About 300 g of white radish was washed and then placed in a peeling device. The radish was sliced using a peeling device (manufactured by Vegg-Q peeler, JC UNI-TEC, Inc.), and then the peeling device was set to provide a slice with a thickness of about 1.5 mm and a width of 10 cm. To the thinly sliced radish, a number of perforations at intervals of about 1 cm using a perforating device.

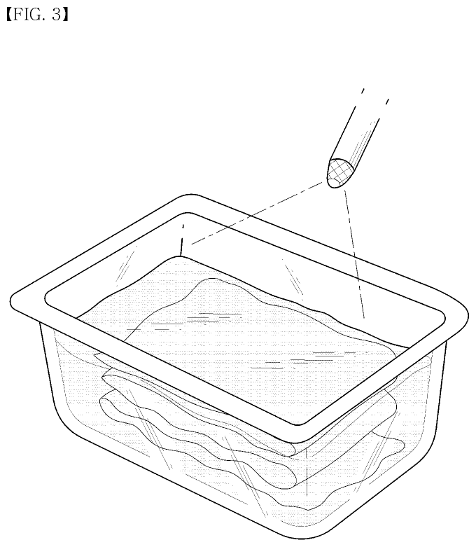

After drilling the perforations, the radish-wrapped was placed in a container, and then ionized water at pH 7.5 was sprayed in the container using an alkaline water ionizer BHL-3100 (available from Alkazone, 200 South Newman Street, Hackensack, N.J. 07601) to provide enough to completely immerse the radish so that it was discolored and deodorized (FIG. 3). In addition, 150 ml vinegar and 3 table spoons (Tbsp) of salt were added thereto, and then it was maintained for about 24 hours to manufacture pickled radish.

After pickling the radish, cactus fruit and red beet 200 g were cut into slices and added to the container, and then they were provided for coloring for 6 hours. After 6 hours, the radish was colored red or purple, and the colored radish-wrapped was taken out of the container and the excess moisture was properly removed, and thereby it was completed in a form that could wrap sushi.

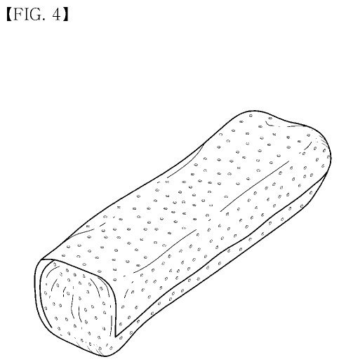

A drawing of the completed form by wrapping sushi using the radish-wrapped manufactured by the method was shown in FIG. 4. However, it is natural that the form of wrapping the ingredients is not necessarily limited only to the form shown in the drawing.

The radish-wrapped for sushi manufactured through the above process was manufactured to not only provide a crunchy texture but also add flavor by slicing radish thinly, and not only help the ingredients inside to appropriately maintain the moisture by drilling perforations at regular intervals, but also add a purple color through natural coloring after bleaching to make a human eating sushi feel palatability more.

So far, the invention made by the present inventors has been described in detail according to the above examples. However, the example only illustrates the content of the present invention, but the scope of the invention is not limited by the examples, and it should be understood that changes are possible within a range that does not depart from the gist of the invention by those skilled in the art.

1. A method of manufacturing radish-wrapped for sushi comprising:
(a) slicing washed radish into a thin and long strip shape;
(b) placing the sliced radish in a container;
(c) adding an ionized alkaline aqueous solution until the radish in the container is completely immersed in it and maintaining it for 18 hours to 30 hours;
(d) adding a coloring agent or natural coloring agent to the ionized alkaline aqueous solution to color the radish;
(e) taking out the radish from the container and discharging excess fluid.

2. The method of manufacturing radish-wrapped for sushi according to claim 1,
wherein the sliced radish in the step (a) has a thickness of 0.25 mm to 1.50 mm, a length of 5 cm to 30 cm, and a width of 3 cm to 30 cm.

3. The method of manufacturing radish-wrapped for sushi according to claim 1,
Further comprising drilling perforations at regular intervals in the sliced radish between the step (a) and step (b).

4. The method of manufacturing radish-wrapped for sushi according to claim 1,
wherein the pH of the ionized alkaline aqueous solution is 7.0 to 10.0 in the step (c).

5. The method of manufacturing radish-wrapped for sushi according to claim 1,
wherein salt and vinegar are added to the ionized alkaline aqueous solution together in the step (c).

6. The method of manufacturing radish-wrapped for sushi according to claim 1,
wherein the coloring the radish is performed for 4 hours to 8 hours in the step (d).

7. The method of manufacturing radish-wrapped for sushi according to claim 1,
wherein the natural coloring agent is one or more kinds selected from the group consisting of green tea, gardenia fruit, carrot, pumpkin, blueberry, red cabbage, purple sweet potato, paprika, omija, gromwell root, safflower, indigo plant, cactus fruit, and red beet.

8. Radish-wrapped for sushi manufactured by the method of claim 1.

9. Radish-wrapped for sushi manufactured by the method of claim 2.

10. Radish-wrapped for sushi manufactured by the method of claim 3.

11. Radish-wrapped for sushi manufactured by the method of claim 4.

12. Radish-wrapped for sushi manufactured by the method of claim 5.

13. Radish-wrapped for sushi manufactured by the method of claim 6.

14. Radish-wrapped for sushi manufactured by the method of claim 7.
